(19) United States
(12) Patent Application Publication
(10) Pub. No.: US 2004/0094469 A1
(43) Pub. Date: May 20, 2004

(54) High-effective squeeze vacuum dehydration machine

(76) Inventor: Wen-Ta Hsieh, Taichung (TW)

Correspondence Address: Charles E. Baxley, Hart, Baxley, Daniels & Holton, Fifth Floor, 59 John Street, New York, NY, 10038, US

(21) Appl. No.: 10/299,258

(22) Filed: Nov. 18, 2002

(51) Int. Cl. B01D 33/044

(52) U.S. Cl. 210/400; 210/402

(57) ABSTRACT

A dehydration machine includes a hollow inner roller having a plurality of first holes defined through a wall thereof and a plurality of longitudinal ribs radial ribs extend from an outer surface of the inner roller. The radial ribs each have second holes and a porous outer tube is mounted and fixed to the longitudinal ribs and the radial ribs so as to squeeze the paper pulp on a belt. A sucking device has a sucking tube inserted in the inner tube and supported by several support frames connected to an inner periphery of the inner roller such that the paper pulp is dehydrated while being squeezed by the outer tube.

### FIELD OF THE INVENTION

The present invention relates to a dehydration machine for dehydrating the paper pulp and includes an inner tube received in an outer tube, wherein the porous inner tube has ribs having holes and a tube of a sucking device is inserted in the inner tube so as to effectively dehydrate the paper pulp squeezed by the outer tube mounted on the inner roller.

### BACKGROUND OF THE INVENTION

A conventional paper pulp dehydration machine is shown in FIGS. 1 and 2 and generally includes a main roller 10 and a squeeze roller 11 which is located in contact with the outer surface of the main roller 10. The paper pulp spread on a belt 12 passes between the main roller 10 and the squeeze roller 11. A plurality of sucking devices 13 are located below the belt 12. The squeeze roller 11 includes an inner roller 15 having holes 14 and a rubber-made outer coating 16 which has holes 17 in alignment with the holes 14 of the inner roller 15. The paper pulp is squeezed by the squeeze roller 11 and the moist and/or water is sucked by the sucking devices 13 via the holes 14 and 17 so as to dehydrate the paper pulp. Nevertheless, it is experienced that the holes 14 and 17 are often blocked by the paper pulp and this becomes a serious problem because the sucking devices 13 keep one sucking the paper pulp to block the holes 14, 17. The outer coating 16 is therefore to be replaced a new one and the holes 17 through the outer coating 16 have to be made manually and this takes a lot of time. The number of the holes 17 is limited for the consuming of the labor efforts and this also restricts the efficiency of the machine.

The present invention intends to provide a dehydration machine that has a high efficiency of ventilation and can be used for a long period of time.

### SUMMARY OF THE INVENTION

In accordance with one aspect of the present invention, there is provided a dehydration machine which comprises a hollow inner roller with first holes defined through a wall thereof and a plurality of longitudinal ribs and radial ribs extend from an outer surface of the inner roller. A porous outer tube is mounted and fixed to the longitudinal ribs and the radial ribs the radial ribs. Each radial rib has second holes and an end of the inner roller is connected to a driving shaft. A sucking device is located in cooperation with the inner roller so as to dehydrate paper pulp on a belt which is squeezed by the rotation of the outer tube.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional paper pulp dehydration machine;

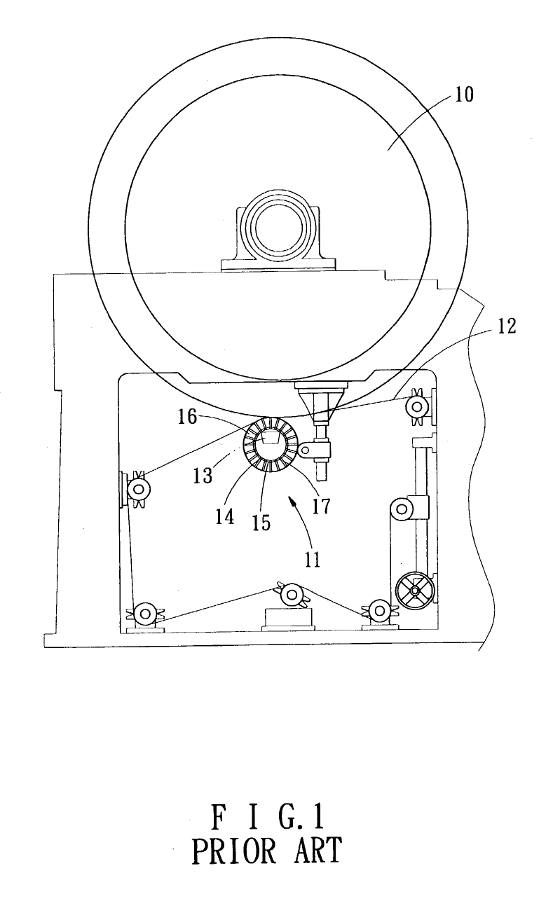

FIG. 2 is an enlarged view to show the squeeze roller of the conventional paper pulp dehydration machine;

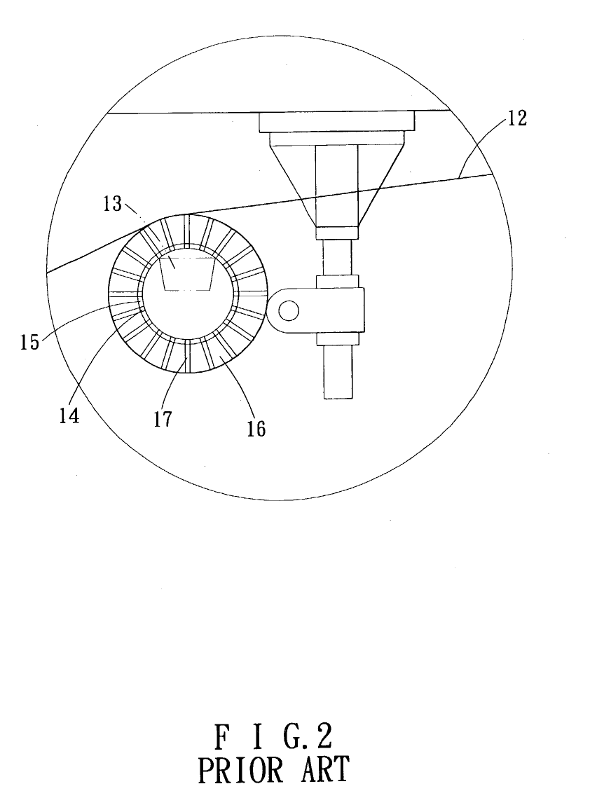

FIG. 3 is a perspective view to show the inner roller and the outer tube of the dehydration machine of the present invention;

FIG. 4 is a cross sectional view to show the inner roller and the outer tube of the dehydration machine of the present invention;

FIG. 5 is a cross sectional end view of the inner roller and the outer tube of the dehydration machine of the present invention, and

FIG. 6 shows the inner roller and the outer tube of the dehydration machine of the present invention is cooperated with two rollers to move the belt on which paper pulp is located.

### DETAILED DESCRIPTION OF THE PREFERRED EMBODIMENT

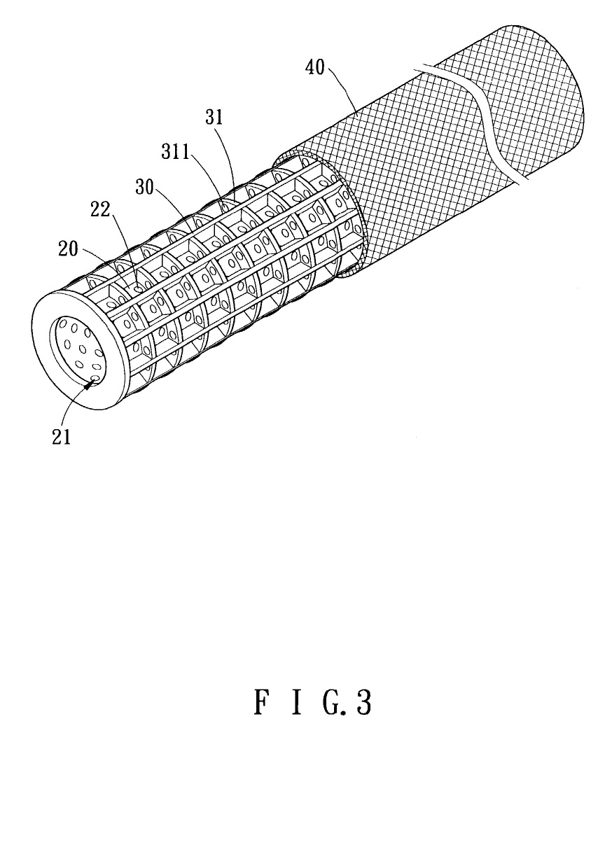

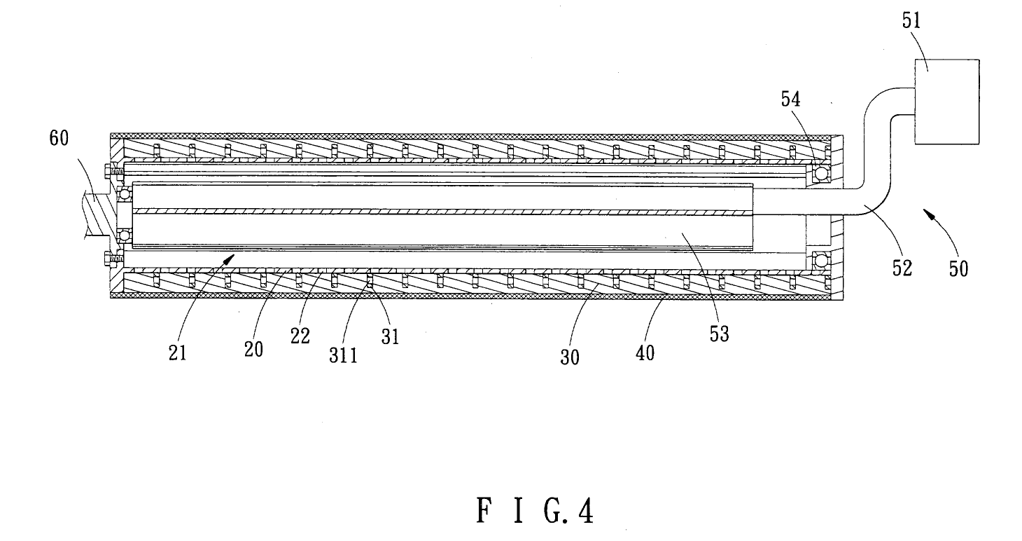

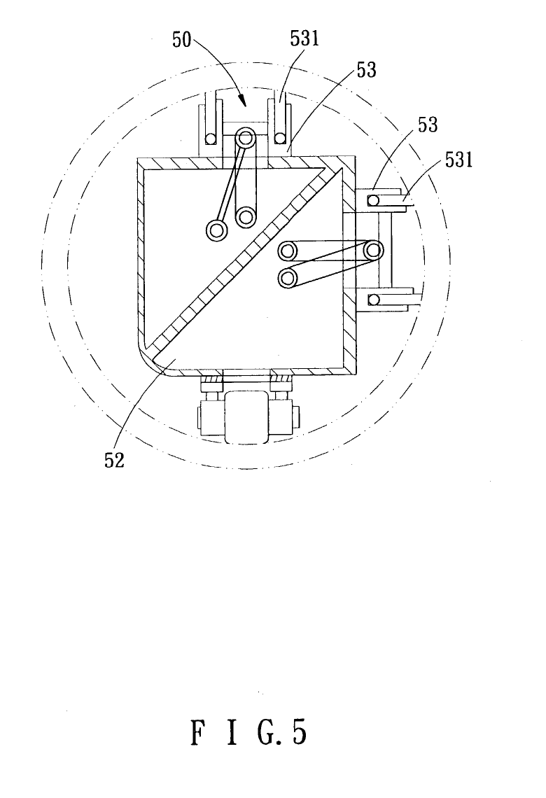

Referring to FIGS. 3 to 5, the dehydration machine of the present invention comprises a hollow inner roller 20 which has a plurality of first holes 22 defined through a wall thereof and an end of the inner roller 20 is connected to a driving shaft 60 which rotate the inner roller 20. A plurality of longitudinal ribs 30 and a plurality of radial ribs 31 extend from an outer surface of the inner roller 20. The radial ribs 31 each have second holes 311 defined therethrough and are perpendicular to the longitudinal ribs 30.

A porous outer tube 40 is mounted and fixed to the longitudinal ribs 30 and the radial ribs 31 such that the inner roller 20 and the outer tube 40 are rotated as a one piece.

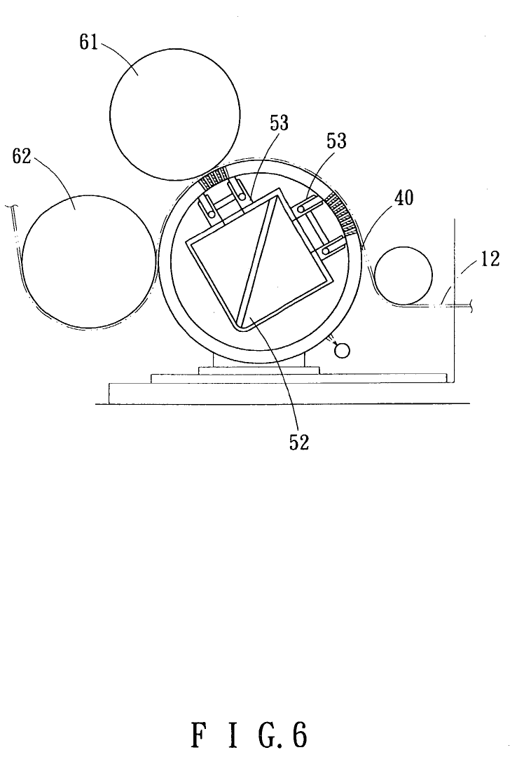

A sucking device 50 is located in cooperation with the inner roller 20 and outside of the inner roller 20 so as to dehydrate paper pulp (shown in FIG. 6) on a belt 12 which is squeezed by the rotation of the outer tube 40 and two rollers 61, 62. The sucking device 50 has a motor 51 from which a sucking tube 52 extends. The sucking tube 52 is inserted in an interior 21 of the inner roller 20 and supported by a plurality of support frames 53. Each support frame 53 has at least one bearing 54 and the sucking tube 52 is not rotated with the rotation of the inner roller 20. The support frames 53 are connected to an inner periphery of the inner roller 20 by several durable pieces 531 which are in contact with the inner periphery of the inner roller 20.

The second holes 311 allow the air ventilation to be more efficient and quickly so that the purpose of dehydration for the paper pulp can be achieved quickly. The porous outer tube 40 can be a netted member which allows air to enter the interior 21 of the inner roller 20 without too much resistance. The longitudinal ribs 30 facilitate the air flow when the driving shaft 60 rotates.

While we have shown and described the embodiment in accordance with the present invention, it should be clear to those skilled in the art that further embodiments may be made without departing from the scope of the present invention.

What is claimed is:

1. A dehydration machine comprising:
a hollow inner roller having a plurality of first holes defined through a wall thereof and a plurality of longitudinal ribs and a plurality of radial ribs extending from an outer surface of the inner roller, the radial ribs each having second holes defined therethrough, an end of the inner roller adapted to be connected to a driving shaft;
a porous outer tube mounted and fixed to the longitudinal ribs and the radial ribs, and
a sucking device located in cooperation with the inner roller so as to be adapted to dehydrate paper pulp on a belt which is squeezed by the rotation of the outer tube.

2. The dehydration machine as claimed in claim 1, wherein the longitudinal ribs are located perpendicular with the radial ribs.

3. The dehydration machine as claimed in claim 1, wherein the sucking device has a motor from which a sucking tube extends, the sucking tube inserted in the inner roller and supported by a plurality of support frames connected to an inner periphery of the inner roller.

4. The dehydration machine as claimed in claim 1, wherein the sucking device is located outside of the inner roller.
